(19) United States
(12) Patent Application Publication
(10) Pub. No.: US 2006/0103325 A1
(43) Pub. Date: May 18, 2006

(54) Plasma display device and driving method with reduced displacement current

(76) Inventor: Joon-Yeon Kim, Suwon-si (KR)

Correspondence Address: CHRISTIE, PARKER & HALE, LLP, PO BOX 7068, PASADENA, CA, 91109-7068, US

(21) Appl. No.: 11/253,357

(22) Filed: Oct. 18, 2005

(30) Foreign Application Priority Data
Nov. 16, 2004 (KR) 10-2004-0093432

(51) Int. Cl. G09G 3/10

(52) U.S. Cl. 315/169.4

(57) ABSTRACT

A plasma display device and a driving method thereof. A scan electrode driver (or a sustain electrode driver) uses a power source for supplying the voltage Vs-Va to increase the initial voltage to the voltage Vs-Va and uses an address voltage output by an address electrode driver to increase the voltage Vs-Va to the voltage Vs to thus apply a sustain discharge pulse during a sustain period. Therefore, the voltage used by a driver for applying the sustain discharge pulse is reduced by using a voltage output by the address driver to apply the sustain pulse voltage.

### CROSS-REFERENCE TO RELATED APPLICATION

This application claims priority to and the benefit of Korean Patent Application 10-2004-0093432 filed in the Korean Intellectual Property Office on Nov. 16, 2004, the entire content of which is incorporated herein by reference.

### BACKGROUND OF THE INVENTION

1. Field of the Invention

The present invention relates to a plasma display device including a plasma display panel (PDP) and a driving method of the plasma display device and, more particularly, to circuits required for generating waveforms of the driving method.

2. Description of the Related Art

Recently, flat panel displays, such as liquid crystal displays (LCDs), field emission displays (FEDs), and plasma display devices have been actively developed. Plasma display devices have features of high luminance, high luminous efficacy, and wide viewing angle. Accordingly, plasma display devices are highlighted as substitutes for conventional cathode ray tubes (CRTs) for large-screen displays of more than 40 inches.

A DC PDP has electrodes exposed to a discharge space without insulation, thereby causing a current to directly flow through the discharge space during application of a voltage to the DC PDP. The DC PDP has a disadvantage in that it requires a resistor for limiting the current. On the other hand, an AC PDP has electrodes covered with a dielectric layer that forms a natural capacitance component to limit the current and protects the electrodes from the impact of ions during discharge. As a result, the AC PDP generally has a longer life than the DC PDP. The plasma display device is driven during a frame including a plurality of subfields with different weights. Each subfield has a reset period, an address period, and a sustain period. During the reset period, the discharge cells are reset in order to stably perform a subsequent address operation on the discharge cells. During the address period, an address voltage is applied to the addressed discharge cells, that are the discharge cells that are turned on, to accumulate wall charges on the discharge cells so as to select the discharge cells that are turned on and the discharge cells that are not turned on. During the sustain period, a discharge occurs by applying a sustain discharge pulse. This discharge causes images to be displayed by the addressed discharge cells.

FIG. 1 shows a conventional plasma display device driving waveform diagram. A sustain discharge pulse with a voltage Vs for a sustain discharge is alternately applied to a scan electrode Y and a sustain electrode X during a sustain period while an address electrode A is biased at a reference voltage (0V in FIG. 1). The voltage Vs is applied to the scan electrode Y to generate a sustain discharge during the sustain period. Negative wall charges are formed at the scan electrode Y and positive wall charges are formed on the sustain electrode X by the sustain discharge. However, the positive wall charges are distributed between the sustain electrode X and the address electrode A so that the wall charges formed at the sustain electrode X are relatively insufficient, and light emission efficiency by sustain discharge is degraded.

### SUMMARY OF THE INVENTION

The present invention provides a plasma display device and a driving method for the plasma display device for improving light emission efficiency.

An exemplary plasma display device according to an embodiment of the present invention includes a PDP, a first driving circuit, a second driving circuit, and a third driving circuit. The PDP includes a plurality of first electrodes and second electrodes and a plurality of third electrodes formed to cross the first and second electrodes. The first driving circuit, the second driving circuit, and the third driving circuit output signals for driving the first electrodes, the second electrodes, and the third electrodes, respectively.

The first driving circuit includes a first switch and a second switch. The first switch is coupled between a first terminal of a first capacitor charged with the first voltage and the first electrode, and supplies the first voltage to the first electrode during a sustain period. The second switch is coupled between the first electrode and a first power source for supplying a second voltage which is less than the first voltage to the first electrode during the sustain period. The third driving circuit includes a third switch and a fourth switch. The third switch is coupled between the third electrode and a second power source for supplying an address voltage to the third electrode during an address period. The fourth switch is coupled between the third electrode and a third power source for supplying a third voltage which is less than the address voltage to the third electrode during the address period. The plasma display device further includes a fifth switch, coupled between a second terminal of the first capacitor and a node of the third switch and the fourth switch, for supplying an output of the node to the second terminal of the first capacitor during the sustain period. The first voltage is generated by subtracting the address voltage from a sustain discharge pulse voltage applied to one of the first electrode and the second electrode during the sustain period.

In a further embodiment, a method is provided for driving a plasma display device including a plurality of first electrodes, a plurality of third electrodes formed to cross the first electrodes, a first driving circuit for driving the first electrodes, and a third driving circuit for driving the third electrodes. The first driving circuit includes a first switch coupled between the first electrode and a first terminal of a first capacitor charged with a first voltage to be supplied to the first electrode, and the plasma display device includes a second switch coupled between a second terminal of the first capacitor and an output node of the third driving circuit. During a sustain period, (a) the first driving circuit is used to increase a voltage at the first electrode to the first voltage; (b) the third driving circuit is used to increase a voltage at the output node of the third driving circuit to an address voltage, and increase a voltage at the first electrode from the first voltage to the second voltage when the second switch is turned on; (c) the voltage at the first electrode is maintained at the second voltage; (d) the third driving circuit is used to decrease the voltage at the output node of the third driving circuit to a third voltage which is lower than the address voltage, and to decrease the voltage at the first electrode from the second voltage to the first voltage when the second switch is turned on; and (e) the first driving circuit is used to decrease the voltage at the first electrode to a fourth voltage which is lower than the first voltage. The first voltage is generated by subtracting the address voltage from the second voltage.

### BRIEF DESCRIPTION OF THE DRAWINGS

FIG. 1 shows a conventional driving waveform for a plasma display device.

FIG. 2 shows a plasma display device according to an embodiment of the present invention.

FIG. 3 shows a driving waveform for a plasma display device according to a first embodiment of the present invention.

FIG. 4 shows a driving circuit for a scan electrode driver according to an embodiment of the present invention.

FIG. 5 shows a driving circuit for a sustain electrode driver according to an embodiment of the present invention.

FIG. 6 shows a driving circuit for an address electrode driver according to a first embodiment of the present invention.

FIG. 7A shows a circuit coupled between a node OUT_A of a driving circuit of an address driver and a floating ground (FG) of a driving circuit of a scan electrode driver.

FIG. 7B shows a circuit coupled between a node OUT_A of a driving circuit of an address driver and a floating ground (FG) of a driving circuit of a sustain electrode driver.

FIG. 8 shows a timing diagram for applying a driving waveform during a sustain period according to a first embodiment of the present invention.

FIG. 9 shows a driving circuit for an address driver according to a second embodiment of the present invention.

FIG. 10 shows a driving waveform during a sustain period and a timing diagram for applying the driving waveform according to a second embodiment of the present invention.

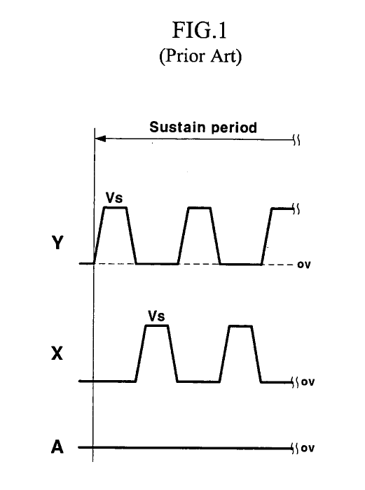

### DETAILED DESCRIPTION

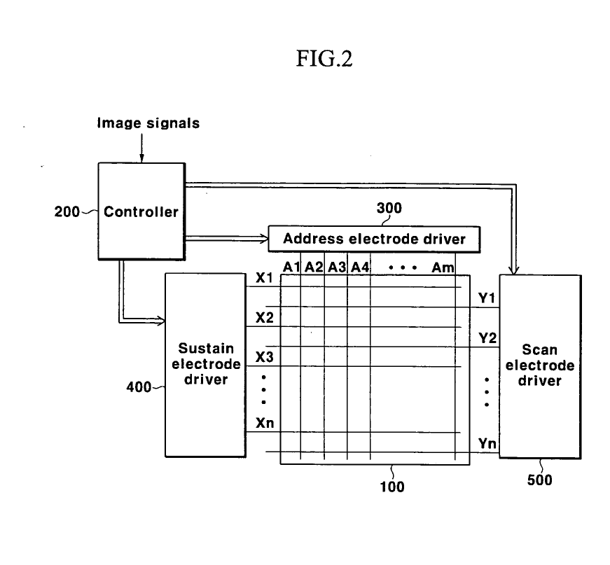

FIG. 2 shows a plasma display device according to an embodiment of the present invention. The plasma display device includes a PDP 100, a controller 200, an address electrode driver 300, a sustain electrode driver 400, and a scan electrode driver 500. The PDP 100 includes a plurality of address electrodes A1 to Am along a column direction, and a plurality of sustain electrodes X1 to Xn and scan electrodes Y1 to Yn arranged in pairs along a row direction. The sustain electrodes X1 to Xn are formed to correspond to the scan electrodes Y1 to Yn, and one of the terminals of the sustain electrodes are coupled in common to those of the scan electrodes. The PDP 100 includes a substrate (not shown) on which the sustain and scan electrodes X1 to Xn and Y1 to Yn are provided, and another substrate (not shown) on which the address electrodes A1 to Am are provided. The two substrates face each other with a discharge space in between so that the scan electrodes Y1 to Yn extend along a direction that crosses the direction of the address electrodes A1 to Am and the sustain electrodes X1 to Xn extend along a direction that crosses the direction of the address electrodes A1 to Am. A discharge space formed at a crossing of the address electrode and the sustain and scan electrodes is referred to as a discharge cell. In addition to the PDP 100, other types of PDPs to which different waveforms are applied are also included in embodiments of this invention. The controller 200 receives an external image signal, and outputs an address electrode A driving control signal, a sustain electrode X driving control signal, and a scan electrode Y driving control signal. The controller 200 divides a frame into a plurality of subfields. Each subfield has a reset period, an address period, and a sustain period.

The address electrode driver 300 receives an address electrode A driving control signal from the controller 200, and applies a display data signal to the address electrodes A for selecting a discharge cell to be displayed. The sustain electrode driver 400 receives a sustain electrode X driving control signal from the controller 200, and applies a driving voltage to the sustain electrode X. The scan electrode driver 500 receives a scan electrode Y driving control signal from the controller 200, and applies a driving voltage to the scan electrode Y.

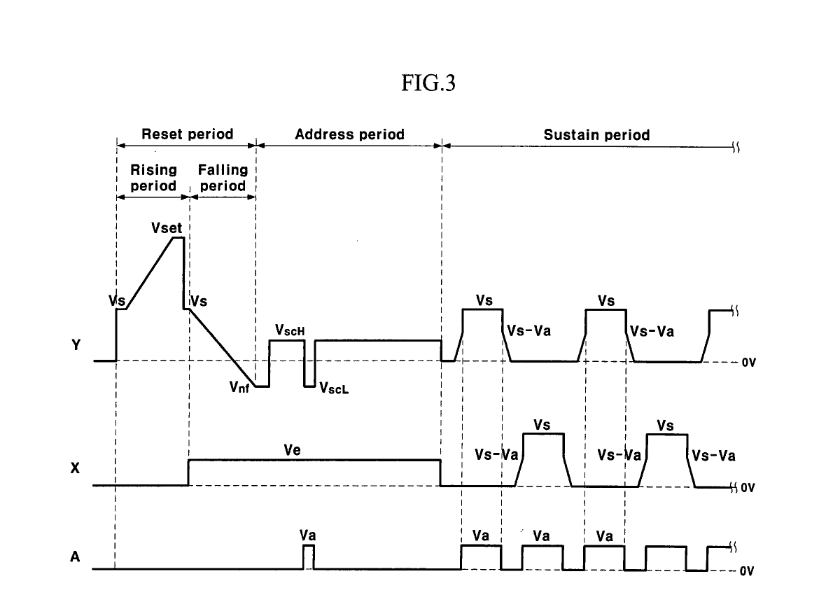

FIG. 3 shows a driving waveform for a plasma display device according to a first embodiment of the present invention. The figure includes the driving waveforms applied to the address electrodes A1 to Am, the sustain electrodes X1 to Xn, and the scan electrodes Y1 to Yn during each subfield. The subsequent description is provided with reference to a discharge cell. Wall charges represent charges formed on the wall, i.e., a dielectric layer, of discharge cells near each electrode and accumulated at the electrode. The terms “formed,” “accumulated,” or “piled” are used for the accumulation of wall charges on a dielectric coating an electrode while the wall charges do not actually contact the electrode. A wall voltage represents a potential difference between the walls of the discharge cells arising due to the accumulation of wall charges.

A reset period is divided into a rising period and a falling period. During the rising period of the reset period, a voltage at the scan electrode Y is gradually increased from a voltage Vs to a voltage Vset while a voltage at the sustain electrode X is maintained at a reference voltage (given as 0V in FIG. 3). A weak reset discharge is generated from the scan electrode Y to the address electrode A and the sustain electrode X so that negative wall charges are formed at the scan electrode Y and positive wall charges are formed at the address electrode A and the sustain electrode X. When the voltage at the scan electrode Y is gradually changed as shown in FIG. 3, a weak discharge is generated in the discharge cells and wall charges are formed so that a sum of an external voltage and the wall voltage within the discharge cells may be maintained at a firing voltage. Discharge cells are to be reset during the reset period, and hence, the voltage Vset is high enough to generate a discharge in the discharge cells. The voltage Vs is a high voltage applied to the scan electrode Y during the sustain period, and is lower than the firing voltage between the scan electrode Y and the sustain electrode X.

The voltage at the scan electrode Y is reduced from the voltage Vs to the voltage Vnf during the falling period of the reset period. During the falling period of the reset period, the reference voltage is applied to the address electrode A and the sustain electrode X is biased at the voltage Ve. While the voltage at the scan electrode Y is reduced, a weak reset discharge is generated between the scan electrode Y and the sustain electrode X and between the scan electrode Y and the address electrode A, and the negative wall charges formed at the scan electrode Y and the positive wall charges formed at the sustain electrode X and the address electrode A are erased. The voltage Vnf is established to be about a firing voltage between the scan electrode Y and the sustain electrode X. The wall voltage between the scan electrode Y and the sustain electrode X almost reaches 0V, and hence, the discharge cells that are not addressed during the address period do not misfire during the sustain period. The wall voltage between the scan electrode Y and the address electrode A is determined by the voltage Vnf because the address electrode A is maintained at the reference voltage (0V in FIG. 3).

A scan pulse with a voltage Vscl is sequentially applied to some of the scan electrodes Y and the remaining scan electrodes Y are biased at a voltage Vsch in order to select the discharge cells during the address period. The voltage Vscl is referred to as a scan voltage, and the voltage Vsch is referred to as a non-scan voltage. An address pulse with the voltage Va is applied to the address electrodes A corresponding to the discharge cells to be selected from among a plurality of discharge cells formed by the scan electrodes Y to which the voltage Vscl is applied, and the address electrodes A which are not selected are biased at the reference voltage. An address discharge is then generated at the discharge cells formed by the address electrodes A to which the voltage Va is applied and the scan electrodes Y to which the voltage Vscl is applied so that positive wall charges are formed at the scan electrodes Y and negative wall charges are formed at the sustain electrodes X.

During the sustain period, a sustain pulse with the voltage Vs is alternately applied to the scan electrode Y and the sustain electrode X. A discharge is then generated between the scan electrode Y and the sustain electrode X by the voltage Vs, applied during the sustain period, and the wall voltage formed between the scan electrode Y and the sustain electrode X by the address discharge during the address period. The sustain discharge pulse applied during the sustain period is first increased from the reference voltage to the voltage Vs-Va and then to the voltage Vs. The sustain discharge pulse is subsequently decreased from the voltage Vs to the voltage Vs-Va, and then from the voltage Vs-Va to the reference voltage. The address electrode A is biased at the address voltage Va during the period when the sustain discharge pulse is increased from the voltage Vs-Va to the voltage Vs and is then decreased from the voltage Vs to the voltage Vs-Va. If the address electrode A is biased at the address voltage Va during the sustain period, as shown in FIG. 3 then no additional power supply is used. It is also possible to apply another voltage to the address electrode A by using another power supply. The voltage Vs-Va may also be varied.

As described above, during the sustain period, when the address electrode A is biased at a positive voltage while the sustain discharge pulse is being applied to the scan electrode Y and the sustain electrode X, an electric field is generated between the scan electrode Y and the address electrode A in addition to an electric field generated between the scan electrode Y and the sustain electrode X. This electric field widens the discharge area, and vacuum UV rays caused by a discharge are more efficiently transmitted to a phosphor layer, thus improving brightness and discharge efficiency of the plasma display device.

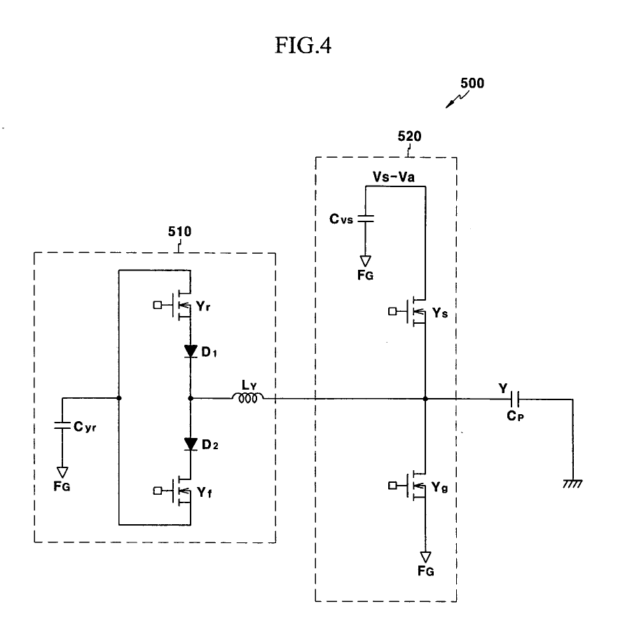

Driver circuits for applying the driving waveform of FIG. 3 are described with reference to FIGS. 4, 5, 6, 7A and 7B. These figures show the driving circuits for applying a driving waveform applied during the sustain period. The reference voltage is a ground voltage (0V).

FIG. 4 shows a driving circuit for a scan electrode driver according to an embodiment of the present invention. The switches in FIG. 4 are shown as N-channel field effect transistors (FETs) with body diodes while other types of switches are also applicable. Capacitance formed by the address electrode A, the scan electrode Y, and the sustain electrode X is illustrated as a panel capacitor Cp.

As shown in FIG. 4, a driving circuit of the scan electrode driver 500 includes a power recovery circuit 510 and a sustain discharge voltage supply 520. The power recovery circuit 510 includes switches Yr and Yf, an inductor Ly, diodes D1 and D2, and a capacitor Cyr. A drain of the switch Yr and a source of the switch Yf are coupled to each other forming a node that is coupled to a first terminal of the capacitor Cyr. The capacitor Cyr is charged with the voltage of (Vs-Va)/2, and a second terminal of the capacitor Cyr is coupled to a floating ground (FG). The diodes D1 and D2 are coupled in series to the switches Yr and Yf and are also coupled together forming a node that is coupled to a first terminal of the inductor Ly. The switches Ys and Yg of the sustain discharge voltage supply 520 are coupled together in series forming a node that is coupled to a second terminal of the inductor Ly. The second terminal of the inductor Ly is coupled in series to a first terminal of the panel capacitor Cp. The first terminal of the panel capacitor Cp corresponds to a scan electrode Y. The diodes D1 and D2 are formed to conduct current in the opposite direction of body diodes of the switches Yr and Yf in order to intercept the current which may occur because of body diodes of the switches Yr and Yf. The diodes D1 and D2 can be eliminated when the switches Yr and Yf have no body diodes.

The above-configured power recovery circuit 510 charges the panel capacitor Cp to be the voltage Vs-Va or discharges it to 0V. The coupling order of the inductor Ly, the diode D1, and the switch Yr in the power recovery circuit 510 can be varied, and the coupling order of the inductor Ly, the diode D2, and the switch Yf can be varied in a similar manner. The sustain discharge voltage supply 520 coupled between the power recovery circuit 510 and the panel capacitor Cp includes two switches Ys and Yg. The switch Ys is coupled between a power source for supplying the voltage Vs-Va and the second terminal of the inductor Ly, and the switch Yg is coupled between the second terminal of the inductor Ly and the floating ground (FG).

The power supply for supplying the voltage Vs-Va includes a capacitor Cvs charged with the voltage Vs-Va whose first terminal is coupled with the switch Ys. A second terminal of the capacitor Cvs is coupled to the floating ground (FG). The switches Ys and Yg supply the voltages Vs-Va and 0V to the panel capacitor Cp.

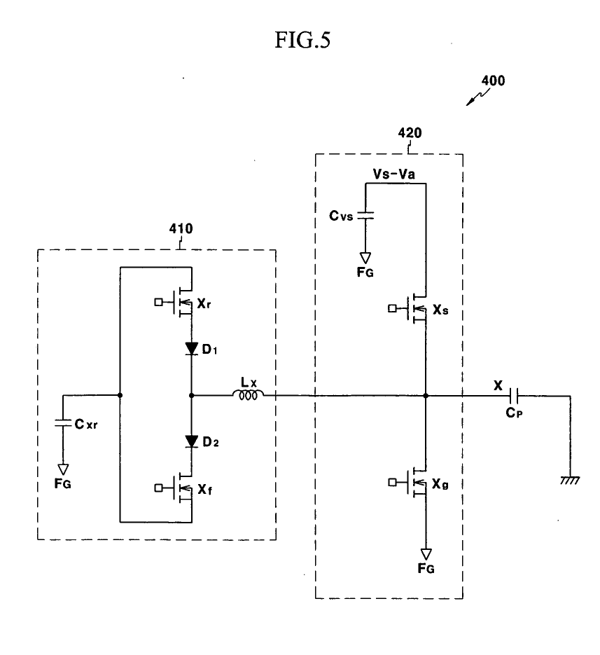

FIG. 5 shows a driving circuit for a sustain electrode driver according to an embodiment of the present invention. As shown in FIG. 5, a driving circuit for applying a driving waveform applied to the sustain electrode X in the sustain electrode driver 400 is similar to the driving circuit of the scan electrode driver 500. Therefore, no repetitive description will be provided.

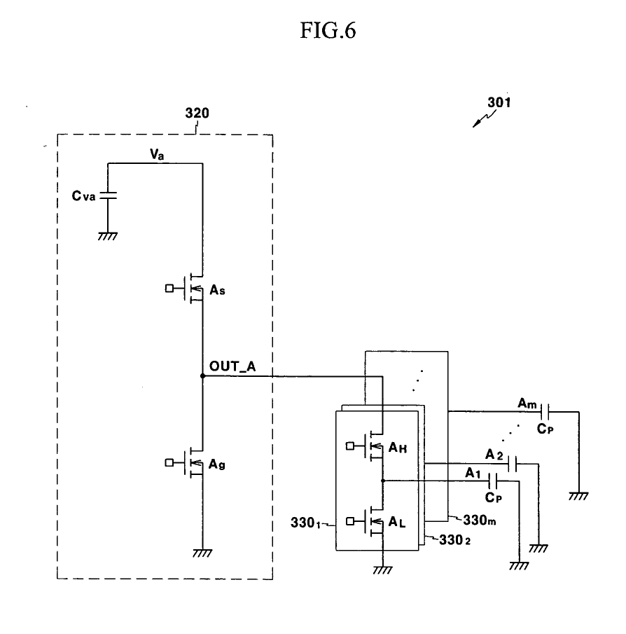

FIG. 6 shows a driving circuit for an address electrode driver 301 according to a first embodiment of the present invention. As shown in FIG. 6, the driving circuit of the address electrode driver 301 includes an address voltage supply 320 and address selection circuits 330₁ to 330ₘ. The address voltage supply 320 includes two switches As and Ag. The switch As of the address voltage supply 320 is coupled between a power source for supplying an address voltage Va and a node formed by coupling of the address selection circuits 330₁ to 330ₘ. The switch Ag is coupled between ground and the same node. The switches As and Ag supply the voltages of Va and 0V to the panel capacitor Cp during the address period and the sustain period, respectively. The address voltage supply 320 further includes a capacitor Cva coupled between the switch As and the ground voltage. The capacitor Cva is charged with the voltage Va and is capable of supplying this voltage.

The address selection circuits 330₁ to 330ₘ are coupled to a plurality of address electrodes A1 to Am, and each include two switches AH and AL. The switch AH of each address selection circuit 330₁ to 330ₘ is coupled between a node OUT_A, formed between the switches As and Ag, and the its corresponding address electrode A1 to Am. The switch AL of each address selection circuit 330₁ to 330ₘ is coupled between its corresponding address electrode A1 to Am and ground. As a result, each of the address electrodes A1 to Am is either selected or not by turn on/off of the switches AH and AL during the address period. More specifically, when one of the switches AH is turned on during the address period, the corresponding address electrode A to which the voltage Va is applied is selected. If the switch AL is turned on in one of the address selection circuits 330₁ to 330ₘ, the address electrode A to which 0V is applied is not selected. The switch AH is always turned on during the sustain period so that the voltage at the node OUT_A is applied to the address electrodes A1 to Am.

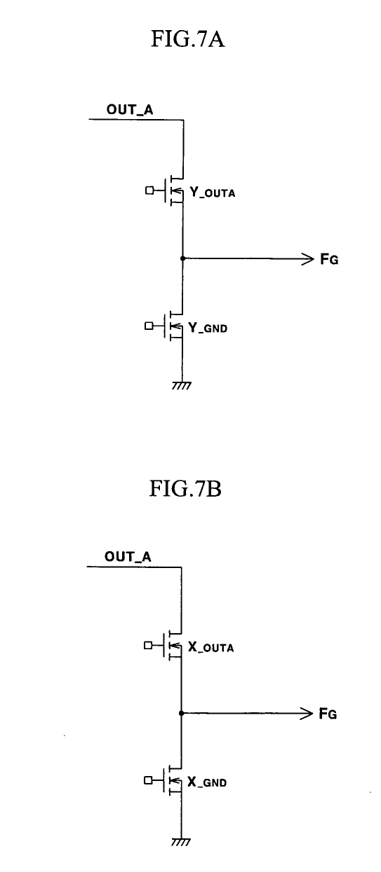

FIG. 7A shows a circuit diagram for coupling the node OUT_A of the driving circuit of the address electrode driver 301 and the floating ground (FG) of the driving circuit of the scan electrode driver 500. FIG. 7B shows a circuit diagram for coupling the node OUT_A of the driving circuit of the address electrode driver 301 and the floating ground (FG) of the driving circuit of the sustain electrode driver 400. The node OUT_A of FIG. 6, FIG. 7A, and FIG. 7B are the same node. The floating ground (FG) of FIG. 7A corresponds to the floating ground (FG) of FIG. 4, and the floating ground (FG) of FIG. 7B corresponds to the floating ground (FG) of FIG. 5.

Referring to FIG. 7A, an output of the node OUT_A is provided to the floating ground (FG) of the driving circuit of the scan electrode driver 500 when a switch Y_{—OUTA} is turned on and a switch Y_GND is turned off. The ground voltage (0V) is provided to the floating ground (FG) of the driving circuit of the scan electrode driver 500 when the switch Y_{OUTA} is turned off and the switch Y_{—GND} is turned on. Referring to FIG. 7B, either an output of the node OUT_A or the ground voltage 0V are provided to the floating ground (FG) of the driving circuit of the sustain electrode driver 400 when the switch X_{—OUTA} or the switch X_{—GND} are turned on, respectively.

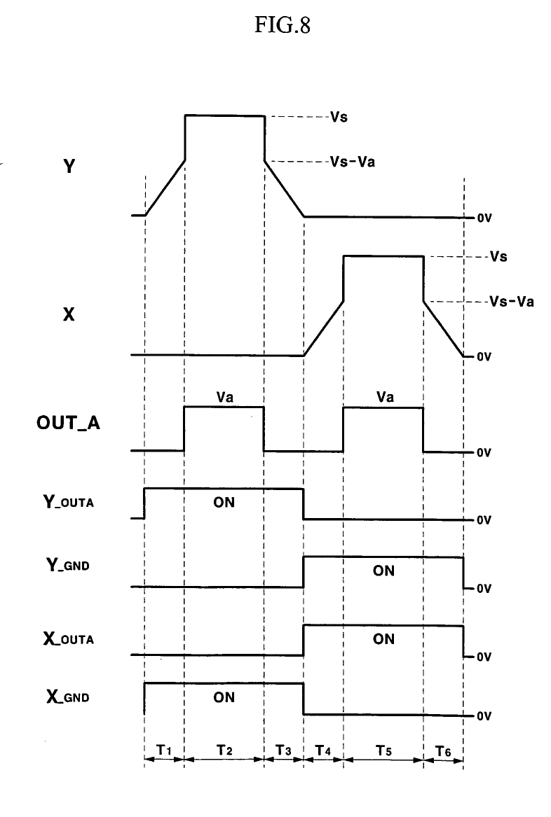

FIG. 8 shows a timing diagram for applying the driving waveforms during the sustain period according to the first embodiment of the present invention. A method for applying the driving waveforms during the sustain period by using the driving circuit of the first embodiment of the present invention is described with reference to FIG. 8.

During the period of T1, the switch Ag of FIG. 6 is turned on, the switch Yr of FIG. 4 is turned on, and the switch Y_{—OUTA} of FIG. 7A is turned on. The output of OUT_A becomes the ground voltage (0V) when the switch Ag is turned on, and the floating ground (FG) becomes the ground voltage (0V) when the switch Y_{—OUTA} is turned on. Therefore, when the switch Yr is turned on, LC resonance is generated in the path of the capacitor Cyr, the switch Yr, the diode D1, the inductor Ly, and the panel capacitor Cp, all shown in FIG. 4. Accordingly, the voltage at the scan electrode Y is increased to approximately Vs-Va while ground voltage (0V) is applied to the floating ground (FG) of the scan electrode driver 500 of FIG. 4.

During the period of T2, the switches As of FIG. 6 and Ys of FIG. 4 are turned on, and the switch Y_{—OUTA} of FIG. 7A remains in the turned-on state. The output at the node OUT_A of the switch As becomes the voltage Va, and the voltage Va is applied to the floating ground (FG) of the scan electrode driver 500 when the switch Y_{—OUTA} is turned on. Because the voltage at the second terminal of the capacitor Cvs (i.e., the floating ground) is increased to the voltage Va, the voltage at the first terminal of the capacitor Cvs is increased from the voltage Vs-Va to the voltage Vs. This, in turn, increases the voltage at the scan electrode Y to reach the voltage Vs. The scan electrode Y is maintained at the voltage Vs when the voltage Va is repeatedly applied to the floating ground (FG) of the scan electrode Y.

In the border of the periods T2 and T3, the switch As is turned off and the switch Ag is turned on so that the output of OUT_A is changed from the voltage Va to the ground voltage (0V), and accordingly, the floating ground (FG) of the scan electrode driver 500 becomes the ground voltage (0V) so that the voltage at the first terminal of the capacitor Cvs is decreased from the voltage Vs to the voltage Vs-Va. Therefore, the voltage at the scan electrode Y is decreased from the voltage Vs to the voltage Vs-Va.

During the period of T3, the switch Ag remains on, and the switch Yf is also turned on. When the switch Yf is turned on, LC resonance is formed in the path of the panel capacitor Cp, the inductor Ly, the diode D2, the switch Yf, and the capacitor Cyr. Because the switch Ag is on, the node OUT_A is at ground (0V), so the voltage at the scan electrode Y is decreased from the voltage Vs-Va to the voltage about 0V.

During the periods of T1, T2, and T3, the switches X_{—GND} and Xg remain on. The ground voltage (0V) is provided to the floating ground (FG) of the sustain electrode driver 400 because the switch X_{—GND} is turned on. Because the switch Xg is on, the ground voltage (0V) is applied to the sustain electrode X. The switching operations of the periods T1, T2, and T3 are applied in a similar manner to the switches corresponding to the sustain electrode driver 400 (shown in FIG. 5, FIG. 6, and FIG. 7B) during the periods of T4, T5, and T6, respectively. No corresponding description is hence provided.

In addition, the switches Y_{—GND} and Yg are turned on during the periods of T4, T5, and T6 so that the ground voltage (0V) is applied to the scan electrode Y. FIG. 8 shows the output voltage at OUT_A, and a voltage corresponding to OUT_A of FIG. 8 is applied to the address electrode A when the switch AH is turned on during the sustain period. The driving waveform during the sustain period according to the first embodiment of the present invention is generated by repeating the operations of the periods of T1 to T6. According to the first embodiment of the present invention, the pulse of the voltage Va is applied to the address electrode A during the sustain period, but a plurality of switching operations are generated by the above-noted pulse, and reactive power consumption of the address electrode A is accordingly increased.

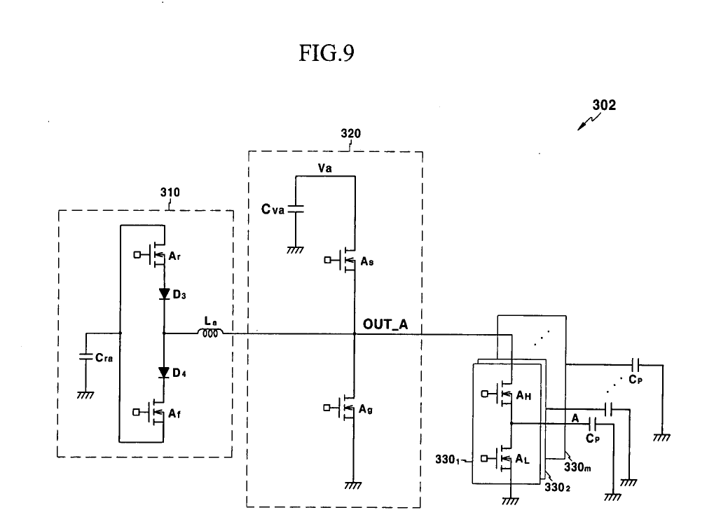

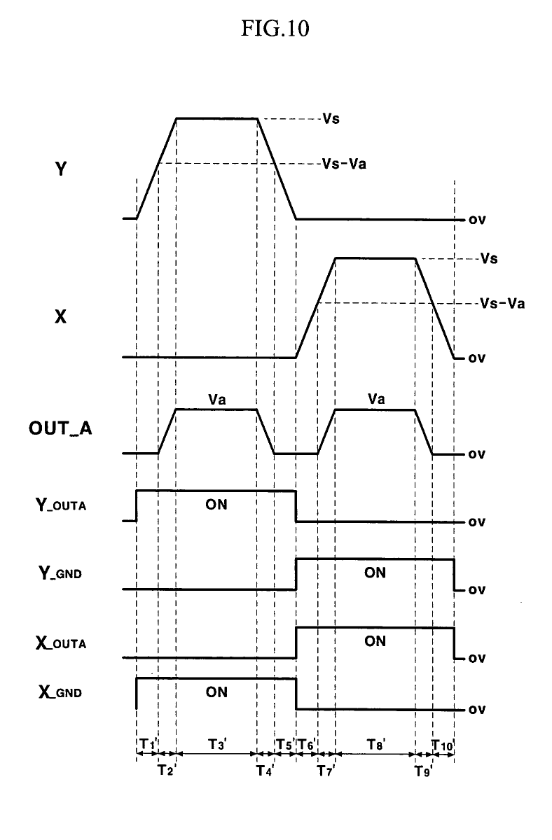

FIG. 9 shows a driving circuit of the address electrode driver 302 according to a second embodiment of the present invention. FIG. 10 shows a driving waveform during the sustain period and a timing diagram for applying the driving waveform according to the second embodiment of the present invention. A method for using a power recovery circuit to apply the voltage Va to the address electrode A during the sustain period and thus reduce reactive power consumption will be described with reference to FIG. 9 and FIG. 10.

As shown in FIG. 9, the driving circuit of the address electrode driver 302 according to the second embodiment of the present invention includes a power recovery circuit 310, an address voltage supply 320, and address selection circuits 330₁ to 330ₘ. This driving circuit is similar to the circuit of the first embodiment shown in FIG. 6 except for the addition of the power recovery circuit 310. No repeated description of the similar parts is hence provided.

The power recovery circuit 310 includes switches Ar and Af, an inductor La, diodes D3 and D4, and a capacitor Cra. The capacitor Cra is charged with the voltage of Va/2. A first terminal of the capacitor Cra for power recovery is coupled to a node formed by a drain of the switch Ar and a source of the switch Af. A second terminal of the capacitor Cra is coupled to the ground voltage. The switches Ar and Af and the diodes D3 and D4 are coupled in series. A first terminal of the inductor La is coupled to a node formed between the diodes D3 and D4. A second terminal of this inductor is coupled to a node formed between the switches As and Ag of the address voltage driver 320. The second terminal of the inductor La is coupled in series to the panel capacitor Cp. The diode D3 is used to establish a rising path for increasing the voltage at the panel capacitor Cp when the switch Ar has a body diode. The diode D4 is used to establish a falling path for decreasing the voltage at the panel capacitor Cp when the switch Af has a body diode. The diodes D3 and D4 can be eliminated when the switches Ar and Af have no body diodes. The above-described power recovery circuit 310 charges the panel capacitor Cp (i.e., the address electrode) with the voltage Va or discharges the this capacitor to 0V. The coupling order of the inductor La, the diode D3, and the switch Ar in the power recovery circuit 310 may be varied, and the coupling order of the inductor La, the diode D4, and the switch Af may also be varied in a similar manner.

The address voltage supply 320 coupled between the address power recovery circuit 310 and the address selection circuits 330₁ to 330ₘ includes two switches As and Ag. The switch As is coupled between the power supply for supplying the address voltage Va and the switch AH of the address selection circuits 330₁ to 330ₘ. The switch Ag is coupled between the power supply for supplying the ground voltage and the switch AH of the address selection circuits 330₁ to 330ₘ. The switches As and Ag respectively supply the voltages Va and 0V to the panel capacitor Cp. The switch AH is always turned on during the sustain period, and the voltage at the node OUT_A is applied to the address electrodes A1 to Am. Also, the node OUT_A of the driving circuit of the address electrode driver 302 is coupled to the floating ground (FG) of the scan electrode driver 500 and the floating ground (FG) of the driving circuit of the sustain electrode driver 400 through the coupling shown in FIG. 7A and FIG. 7B.

A method for using the driving circuit of the address driver 302 of FIG. 9 to apply the driving waveforms of FIG. 10 during the sustain period is described below.

As shown in FIG. 10, a sustain discharge pulse applied to the scan electrode Y and the sustain electrode X during the sustain period is increased from the reference voltage to the voltage Vs-Va and subsequently to the voltage Vs, and then decreased from the voltage Vs to the voltage Vs-Va and further decreased from voltage Vs-Va back to the reference voltage. The voltage at the address electrode A is increased from the reference voltage to the voltage Va and is then decreased from the voltage Va back to the reference voltage during the period in which the sustain pulse is increased from Vs-Va to Vs and then decreased from Vs to Vs-Va. Accordingly, in the second embodiment of the present invention, the voltage Va is applied to the address electrode A by using LC resonance of the power recovery circuit 310, and the sustain pulse is not steeply increased from the voltage Vs-Va to the voltage Vs, but is rather increased with the gradient of LC resonance.

A method for applying the driving waveforms of the second embodiment of the invention during the sustain period is described in more detail with reference to FIG. 9 and FIG. 10.

During the period of T1′, the switch Ag of FIG. 9 is turned on, the switch Yr of FIG. 4 is turned on, and the switch Y_{—OUTA} of FIG. 7A is turned on. The output of OUT_A becomes the ground voltage (0V) when the switch Ag is turned on, and the floating ground (FG) becomes the ground voltage (0V) when the switch Y_{—OUTA} is turned on. Therefore, while the ground voltage (0V) is applied to the floating ground (FG) of the scan electrode driver 500 shown in FIG. 4, LC resonance is formed in the path of the capacitor Cyr, the switch Yr, the diode D1, the inductor Ly, and the panel capacitor Cp to increase the voltage at the scan electrode Y to about the voltage Vs-Va when the switch Yr is turned on.

During the period of T2′, the switch Ar of FIG. 9 is turned on, the switch Ys of FIG. 4 is turned on, and the switch Y_{—OUTA} remains in the turned-on state. When the switch Ar is turned on, LC resonance is formed in the path of the capacitor Cra, the switch Ar, the diode D3, the inductor La, and the panel capacitor Cp to increase the voltage at the address electrode A to be about the voltage Va. Therefore, the voltage at the node OUT_A is increased to the voltage Va as shown in FIG. 10, and the voltage of OUT_A increasing to the voltage Va is applied to the floating ground (FG) of the scan electrode driver 500 when the switch Y_{—OUTA} is on. Because the voltage at the second terminal of the capacitor Cvs, the floating ground (FG) of the scan electrode driver 500, is increased to the voltage Va, the voltage at the first terminal of the capacitor Cvs is increased from Vs-Va to Vs, and the voltage at the scan electrode Y is increased to Vs.

During the period of T3′, the switch As of FIG. 9 is turned on, the switch Ys of FIG. 4 maintains the turned-on state, and the switch Y_{—OUTA} maintains the turned-on state. When the switch As is turned on, the voltage Va is applied to the node OUT_A. Because the switch Y_{—OUTA} remains on, the voltage Va is applied to the floating ground (FG). Because the switch Ys remains on and the voltage Va is applied to the floating ground (FG), the voltage Vs is applied to the scan electrode Y.

During the period of T4′, the switch Af of FIG. 9 is turned on, the switch Ys of FIG. 4 remains on, and the switch Y_{—OUTA} also remains on. When the switch Af is turned on, LC resonance is formed in the path of the panel capacitor Cp, the inductor La, the diode D4, the switch Af, and the capacitor Cra. While the switch Y_{—OUTA} is on, the voltage at the node OUT_A is decreased from Va to 0V, and the floating ground (FG) is decreased from Va to 0V. Because the floating ground (FG) is decreased from Va to 0V, the voltage at the first terminal of the capacitor Cvs is decreased from Vs to Vs-Va. Because the switch Ys remains on, the voltage Vs-Va is applied to the scan electrode Y.

During the period of T5′, the switch Ag of FIG. 9 is turned on, the switch Yf of FIG. 4 is turned on, and the switch Y_{—OUTA} remains on. Because the switch Ag is turned on, the voltage at the node OUT_A becomes the ground voltage (0V). Because the switch Y_{—OUTA} remains on, the ground voltage (0V) is applied to the floating ground (FG) of the scan electrode driver 500. Because the switch Yf is turned on while the ground voltage is applied to the floating ground (FG) of the scan electrode driver 500, LC resonance is formed in the path of the panel capacitor Cp, the inductor Ly, the diode D2, the switch Yf, and the capacitor Cyr to decrease the voltage at the scan electrode Y from Vs-Va to about the ground voltage (0V).

During the periods of T1′ to T5′, the switch Xg of FIG. 5 and the switch X_{—GND} of FIG. 7B are turned on. The ground voltage (0V) is applied to the floating ground (FG) of the sustain electrode driver 400 while the switch X_{—GND} is turned on. The ground voltage (0V) is applied to the sustain electrode X because the ground voltage (0V) is applied to the floating ground (FG) of the sustain electrode driver 400 and the switch Xg is turned on.

During the periods of T6′ to T10′, the operations described for the switches corresponding to the scan electrode driver 500 during the periods of T1′ to T5′, are applicable in a similar manner to the switches corresponding to the sustain electrode driver 400 (refer to FIG. 5, FIG. 7B, and FIG. 9). Hence, no corresponding description is provided. In addition, during the periods of T6′ to T10′, the switches Y_{—GND} and Yg are turned on, and the ground voltage (0V) is applied to the scan electrode Y.

FIG. 10 shows the output voltage at the node OUT_A, which is applied to the address electrode A when the switch AH of FIG. 9 is turned on during the sustain period. The driving waveform during the sustain period according to the second embodiment of the present invention is generated by repeating the operations of the periods of T1′ to T10′. The voltage Vs of the sustain discharge pulse applied during the sustain period is decreased by the amount of voltage Va, and the voltage Vs-Va is then used as the voltage of the power supply for driving the sustain or scan electrodes X, Y. Because the power supply is now supplying a voltage Vs-Va, the sustain and scan electrode driver circuits 400, 500 need only pull this voltage up by a voltage Va to be equal to the required voltage Vs. As a result of apply a voltage Vs-Va by the power supply, the sustain and scan electrode driver circuits 400, 500 are ahead by the voltage Va. If Va is taken as approximately half of Vs, then the sustain and scan electrode driver circuits of this invention 400, 500 generate substantially only half the displacement current occurring in prior art. But, this half current occurs twice.

That is, as shown in FIG. 8 and FIG. 10, because the displacement current flows during the period in which the voltage of the sustain discharge pulse of the scan electrode Y (or the sustain electrode X) is increased from the voltage 0V to the voltage Vs-Va and during the period in which the voltage at the address electrode A is increased from the ground voltage (0V) to the voltage Va, half the displacement current flows twice compared to the prior art, and the thermal loss caused by a parasitic component on the current path is reduced to half. Assuming a current of I for the prior art cases, the thermal loss generated in prior art is RIˆ2. In the embodiments of the current invention, a current of 1/2*I flows twice that generates a thermal loss of 2* R (1/2*I)ˆ2=1/2*RIˆ2 which is one half of the thermal loss generated in prior art. Further, since the scan electrode driver 500 and the sustain electrode driver 400 use the voltage Vs-Va to generate the voltage Vs during the sustain period, withstanding voltages of the switches are also reduced which in turn reduce circuit costs.

Recently, the partial pressure of Xe used in the PDP is being increased in order to improve discharge efficiency, and the voltage Vs of the sustain discharge pulse is increased to add a circuit load to a synaptic plasma membrane (SPMs) when high Xe is used. Therefore, using a driver according to the embodiments of the present invention, reduces the circuit load caused by an increase of the voltage of the sustain discharge pulse.

According to embodiments of the present invention, the voltage output by the address driver is used to apply the sustain discharge pulse voltage, thus reducing the voltage used by the driver for applying the sustain discharge pulse. Accordingly, the displacement current is reduced to substantially half thus reducing the thermal loss caused by the parasitic component on the current path. Further, the withstanding voltage of the driver for applying the sustain discharge pulse is reduced to decrease the circuit cost.

Moreover, an electric field is formed between the scan electrode Y and the address electrode A in-addition to the electric field between the sustain electrode X and the scan electrode Y by applying a voltage pulse of Va to the address electrode while the sustain discharge pulse is applied during the sustain period. As a result, the discharge area is enlarged and vacuum UV rays generated by the discharge are more efficiently transmitted to the phosphor layer, thereby improving brightness and discharge efficiency of the plasma display device.

While this invention has been described in connection with exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display device comprising:
a plasma display panel having a plurality of first electrodes, a plurality of second electrodes, the first electrodes and the second electrodes extending along a first direction, and a plurality of third electrodes extending along a second direction, the second direction crossing the first direction; and
a first driving circuit, a second driving circuit, and an third driving circuit for outputting signals for driving the first electrodes, the second electrodes, and the third electrodes, respectively,
wherein the first driving circuit includes:
a first switch for supplying a first voltage to the first electrode during a sustain period, the first switch being coupled between a first terminal of a first capacitor charged with the first voltage and the first electrode, and
a second switch for supplying a second voltage which is less than the first voltage to the first electrode during the sustain period, the second switch being coupled between the first electrode and a second voltage source,
wherein the third driving circuit includes:
a third switch for supplying an address voltage to the third electrode during an address period, the third switch being coupled between the third electrode and an address voltage source; and
a fourth switch for supplying a third voltage which is less than the address voltage to the third electrode during the address period, the fourth switch being coupled between the third electrode and a third voltage source, and
a fifth switch for supplying an output of a node of the third switch and the fourth switch to a second terminal of the first capacitor during the sustain period, the fifth switch being coupled between the second terminal of the first capacitor and the node.

2. The plasma display device of claim 1, wherein the first voltage is generated by subtracting the address voltage from a sustain discharge pulse voltage applied to one of the first electrode and the second electrode during the sustain period.

3. The plasma display device of claim 1, wherein one of the address voltage and the third voltage is supplied to the second terminal of the first capacitor through operations of the third switch and the fourth switch during the sustain period.

4. The plasma display device of claim 2, wherein the first switch, the third switch, and the fifth switch are turned on to apply the sustain discharge pulse voltage to the first electrode during the sustain period.

5. The plasma display device of claim 4, wherein the first switch, the fourth switch, and the fifth switch are turned on to apply the first voltage to the first electrode during the sustain period.

6. The plasma display device of claim 5, wherein the first driving circuit further includes:
an inductor having a first terminal coupled to the first electrode;
a fourth voltage source for supplying a resonance voltage;
a sixth switch coupled between the fourth voltage source and a second terminal of the inductor; and
a seventh switch coupled between the fourth voltage source and the second terminal of the inductor,
wherein a current path of the fourth voltage source, the sixth switch, the inductor, and the third electrode is formed to increase a voltage at the first electrode to the first voltage when the sixth switch is turned on during the sustain period, and
wherein a current path of the third electrode, the inductor, the seventh switch, and the fourth voltage source is formed to decrease the voltage at the first electrode to the second voltage when the seventh switch is turned on during the sustain period.

7. The plasma display device of claim 1, wherein the third driving circuit further includes:
an inductor having a first terminal coupled to the third electrode;
a fourth voltage source for supplying a resonance voltage;
a sixth switch coupled between the fourth voltage source and a second terminal of the inductor; and
a seventh switch coupled between the fourth voltage source and the second terminal of the inductor,
wherein a current path of the fourth voltage source, the sixth switch, the inductor, and the first electrode is formed to increase a voltage at the second terminal of the first capacitor to the address voltage when the sixth switch is turned on during the sustain period, and
a current path of the first electrode, the inductor, the seventh switch, and the fourth voltage source is formed to decrease the voltage at the second terminal of the first capacitor to the third voltage when the seventh switch is turned on during the sustain period.

8. The plasma display device of claim 1, wherein the third driving circuit further includes:
a plurality of selection circuits including a sixth switch having a first terminal coupled to the node and a second terminal coupled to the third electrode; and
a seventh switch having a first terminal coupled to the third voltage source and a second terminal coupled to the third electrode, and
wherein the sixth switch is turned on during the sustain period.

9. A method for driving a plasma display device having a plurality of first electrodes, a plurality of second electrodes formed to cross the first electrodes, a first driving circuit for driving the first electrodes, and a second driving circuit for driving the second electrodes, during a sustain period, the method comprising:
using the first driving circuit, which includes a first switch coupled between the first electrode and a first terminal of a first capacitor charged with a first voltage to be supplied to the first electrode, to increase a voltage at the first electrode to the first voltage;
using the second driving circuit to increase a voltage at an output node of the second driving circuit to an address voltage, and to increase a voltage at the first electrode from the first voltage to a second voltage when a second switch coupled between a second terminal of the first capacitor and the output node of the second driving circuit is turned on;
maintaining the voltage at the first electrode at the second voltage;
using the second driving circuit to decrease the voltage at the output node of the second driving circuit to a third voltage which is lower than the address voltage, and decrease the voltage at the first electrode from the second voltage to the first voltage when the second switch is turned on; and
using the first driving circuit to decrease the voltage at the first electrode to a fourth voltage which is lower than the first voltage.

10. The method of claim 9, wherein the first voltage is generated by subtracting the address voltage from the second voltage.

11. The method of claim 9, wherein the second driving circuit includes a third switch coupled between the second electrode and a first voltage source for supplying the address voltage to the output node of the second driving circuit, and a fourth switch coupled between the second electrode and a second voltage source for supplying the third voltage to the output node of the second driving circuit,
wherein using the second driving circuit to increase the voltage at the output node of the second driving circuit to the address voltage includes turning on the third switch, and
wherein using the second driving circuit to decrease the voltage at the output node of the second driving circuit to the third voltage includes turning on the fourth switch.

12. The method of claim 9, wherein the second driving circuit includes a third switch, a fourth switch, and an inductor, the method further comprising:
wherein using the second driving circuit to increase the voltage at the output node of the second driving circuit to the address voltage includes generating resonance between the inductor and a panel capacitor formed between the first and second electrodes through the third switch, and
wherein using the second driving circuit to decrease the voltage at the output node of the second driving circuit to the third voltage includes generating resonance between the inductor and the panel capacitor through the fourth switch.

13. The method of claim 9, wherein the voltage at the output node of the second driving circuit is applied to the second electrode during the using of the second driving circuit to increase a voltage at the output node of the second driving circuit to an address voltage, during the maintaining of the voltage at the first electrode at the second voltage, and during the using of the second driving circuit to decrease the voltage at the output node of the second driving circuit to a third voltage which is lower than the address voltage.

14. The method of claim 9, wherein the third voltage and the fourth voltage have the same voltage level.
